(19) United States
(12) Patent Application Publication
(10) Pub. No.: US 2005/0162610 A1
(43) Pub. Date: Jul. 28, 2005

(54) Sunshade clip attachable to spectacles

(76) Inventors: Kwang Nam Kim, Daegu (KR); Kyung Nam Kim, Daegu (KR)

Correspondence Address: JACOBSON HOLMAN PLLC, 400 SEVENTH STREET N.W., SUITE 600, WASHINGTON, DC, 20004, US

(21) Appl. No.: 10/875,183

(22) Filed: Jun. 25, 2004

(30) Foreign Application Priority Data
Jan. 28, 2004 (KR) 20-2004-0002011

(51) Int. Cl. G02C 9/00

(52) U.S. Cl. 351/47

(57) ABSTRACT

Disclosed herein is a sunshade clip attachable to spectacles, which can allow a fragrance to be continuously emitted from a perfume injected in the spectacles and the sunshade clip for a certain long time, thereby creating a pleasant atmosphere around a wearer of the spectacles. In such spectacles comprising a pair of lens frames for retaining prescription lenses, respectively, a nose frame connecting adjacent inner ends of both the lens frames, and temple arms extended rearward from opposite outer ends of both the lens frames for allowing the spectacles to be worn on the wearer's ears, a pair of attachment units are provided for detachably attaching the sunshade clip to the spectacles. The present invention enables the fragrance to be emitted from the respective components of the spectacles and/or the sunshade clip, and/or the attachment units.

### BACKGROUND OF THE INVENTION

1. Field of the Invention

The present invention relates to a sunshade clip attachable to spectacles, and more particularly to an attachment unit used to attach a sunshade clip to spectacles with an improved wearability.

2. Description of the Related Art

Ordinary spectacles, for persons having to correct defective vision, basically comprise a pair of left and right lens frames for retaining prescription lenses, a nose frame connecting between both the lens frames, and temple arms extended rearward from opposite outer ends of the lens frames for allowing the spectacles to be worn on the user's ears.

Sunshade clips are articles intended to be worn by wearers of spectacles in a season with strong ultraviolet rays, such as the summer, instead of sunglasses. Such a sunshade clip is detachably attached to the front of spectacles by means of attachment means.

Currently, various kinds of attachment means have been already developed and used for detachably attaching a sunshade clip to spectacles, and features of these attachment means will now be explained.

In general, such attachment means for a sunshade clip comprises a pair of attachable pieces, each of which is fixed to spectacles or the sunshade clip so that it protrudes outward. After these attachable pieces are positioned to conjoin to each other for coupling therebetween, magnets are incorporated in the attachable pieces, respectively.

Such a general sunshade clip attachment means, however, has no other function except for a simple function of attaching a sunshade clip to spectacles.

For this reason, when spectacles are worn by the wearer in the summer with a high outside temperature or for a long time, moisture containing salt, such as sweat, or other waste matter of the human body may be deposited on respective components of the spectacles, in particular, their connecting components, giving rise to a bad smell.

This makes the wearer feel unpleasant, and disturbs people near the wearer or partners in conversation.

### SUMMARY OF THE INVENTION

Therefore, the present invention has been made in view of the above problems, and it is an object of the present invention to enable a fragrance to be emitted from respective components of spectacles, such as lens frames, a nose frame, or temple arms as well as a sunshade clip attachable to the spectacles or usual sunglasses, thereby creating a pleasant atmosphere around a wearer of the spectacles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partially broken away perspective view illustrating a sunshade clip attachable to spectacles in accordance with the present invention;

FIG. 2 is a partially broken away perspective view illustrating an attachment unit, which is used to detachably attach a sunshade clip to spectacles, in accordance with a first embodiment of the present invention;

FIG. 3 is a partially broken away perspective view illustrating an alternative embodiment of the attachment unit shown in FIG. 2;

FIG. 4 is a side sectional view illustrating a coupled state of the attachment unit in accordance with the first embodiment of the present invention;

FIG. 5 is a partially broken away perspective view illustrating an attachment unit in accordance with a second embodiment of the present invention;

FIG. 6 is a partially broken away perspective view illustrating an alternative embodiment of the attachment unit shown in FIG. 5;

FIG. 7 is a side sectional view illustrating a coupled state of the attachment unit in accordance with the second embodiment of the present invention;

FIG. 8 is a partially broken away perspective view illustrating an attachment unit in accordance with a third embodiment of the present invention;

FIG. 9 is a partially broken away perspective view illustrating an alternative embodiment of the attachment unit shown in FIG. 8;

FIG. 10 is a side sectional view illustrating a coupled state of the attachment unit in accordance with the third embodiment of the present invention;

FIG. 11 is a partially broken away perspective view illustrating an attachment unit in accordance with a fourth embodiment of the present invention;

FIG. 12 is a partially broken away perspective view illustrating an alternative embodiment of the attachment unit shown in FIG. 11;

FIG. 13 is a side sectional view illustrating a coupled state of the attachment unit in accordance with the fourth embodiment of the present invention;

FIG. 14 is a partially broken away perspective view illustrating an attachment unit in accordance with a fifth embodiment of the present invention;

FIG. 15 is a side sectional view illustrating a coupled state of the attachment unit in accordance with the fifth embodiment of the present invention;

FIG. 16 is a partially broken away perspective view illustrating an attachment unit in accordance with a sixth embodiment of the present invention; and

FIG. 17 is a side sectional view illustrating a coupled state of the attachment unit in accordance with the sixth embodiment of the present invention.

### DESCRIPTION OF THE PREFERRED EMBODIMENTS

Now, preferred embodiments of the present invention will be described in detail with reference to the annexed drawings.

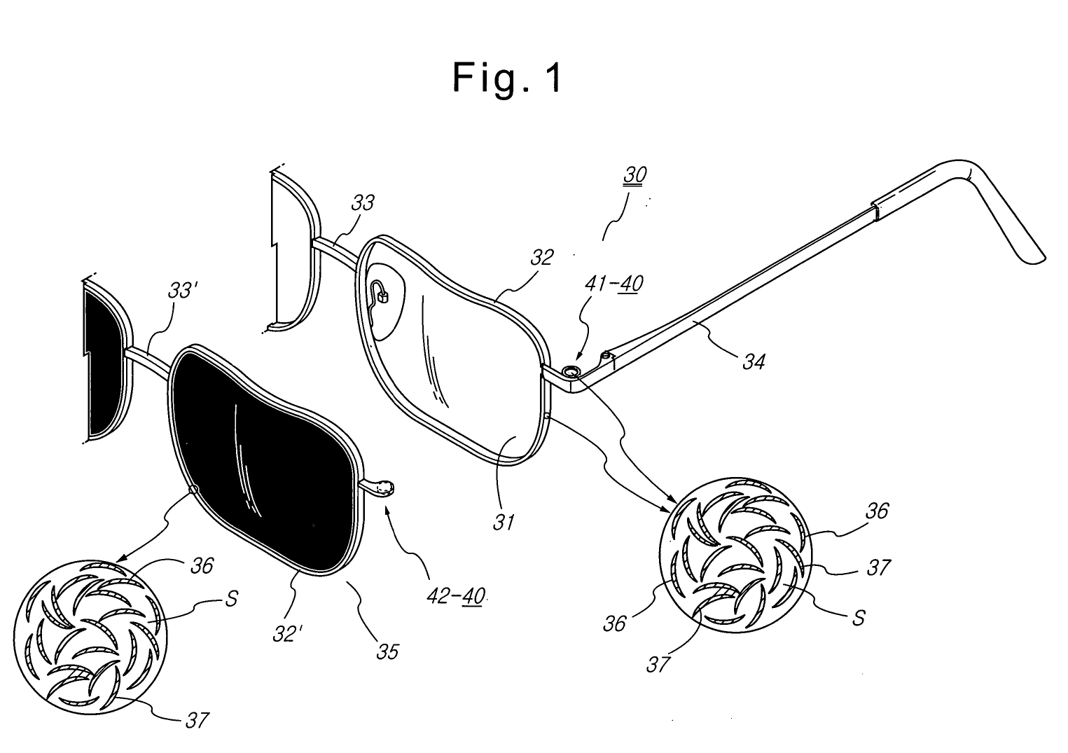

FIG. 1 is a partially broken away perspective view illustrating a sunshade clip attachable to spectacles in accordance with the present invention.

Conventionally, spectacles 30 comprise a pair of lens frames 32 for retaining lenses 31, a nose frame 33 connecting adjacent inner ends of both the frames 32, and temple arms 34 extended rearward from opposite outer ends of both the frames 32 for allowing the spectacles 30 to be worn on the wearer's ears. Similarly, a sunshade clip 35 attachable to the spectacles 30 comprises a pair of the lens frames 32′, and a nose frame 33′ connecting adjacent inner ends of both the frames 32′.

One feature of the present embodiment is that the above respective components of the spectacles 30, namely, the lens frames 32, nose frame 33, and temple arms 34, as well as an attachment unit 40 for detachably attaching a sunshade clip 35 to the spectacles 30, are designed to emit a sweet fragrance, thereby improving wearbility of the spectacles 30 and the sunshade clip 35 and creating a pleasant atmosphere.

For this, the respective components of the spectacles 30 and of the sunshade clip 35 are formed by sintering metal fibers, each having a length of 50 μm to 500 μm and a thickness of 10 μm to 100 μm obtained through grinding of raw metal, to have a porosity of 30% to 90% and a density of 0.7 g/cc to 6.0 g/cc, and injecting a perfume into fine voids (S) inherent between the sintered metal fibers 36 and 37, thereby allowing a fragrance to be continuously emitted therefrom for a certain long time.

Of course, the perfume is changeable by heating the sintered metal fibers 36 and 37 until the perfume is completely dried, and again injecting new one.

Alternatively, instead of directly forming the respective components of the spectacles 30 by making use of the sintered metal fibers 36 and 37, the sintered metal fibers 36 and 37 may be formed into an attachable pad, which is attachable to appropriately selected positions of the spectacles 30.

It should be clearly understood that the sintered metal fibers 36 and 37 are further applicable to the sunshade clip 35 attachable to the spectacles 30 or other sunglasses, as well as the attachment unit 40, which is employed for detachably attaching the sunshade clip 35 to the spectacles 30.

In the case of applying the attachment unit 40, preferably, the sintered metal fibers 36 and 37 are contained in clip attachable means of the attachment unit 40, which is integrated to the spectacles 30 as ordinary daily articles in order to allow the wearer to constantly smell a fragrance. In this case, into spectacles attachable means of the attachment unit 40 integrated to the sunshade clip 35 is incorporated a magnet 43 capable of producing strong attraction relative to the clip attachable means.

Advantageously, the sintered metal fibers 36 and 37 contain more Fe than stainless steel or Cu based materials in order to be easily attractable by the magnet 43.

The metal fibers 36 and 37 consist of 0.021% by weight of carbon (C), 0.89% by weight of silicone (Si), 0.24% by weight of manganese (Mn), 0.02% by weight of phosphorous (P), 0.007% by weight of sulfur (S), 0.16% by weight of nickel (Ni), 16.33% by weight of chrome (Cr), 0.01% by weight of molybdenum (Mo), 0.01% by weight of copper (Cu), and 82.312% by weight of iron (Fe).

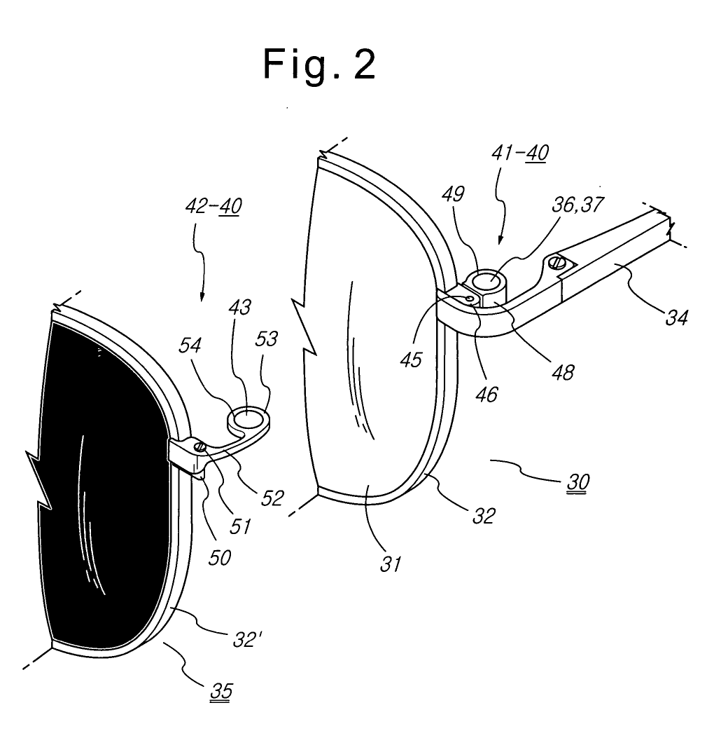

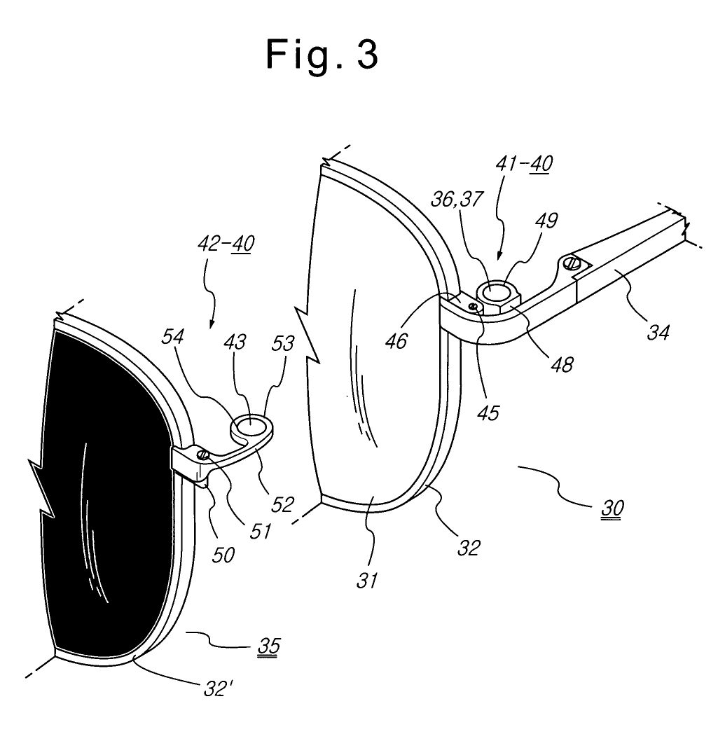

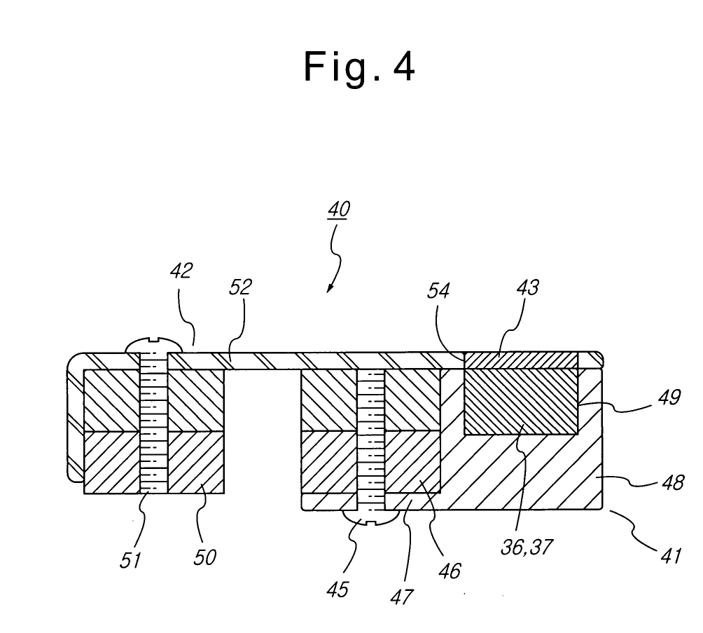

Reference is now made to FIGS. 2 to 4. FIG. 2 is a partially broken away perspective view illustrating an attachment unit, which is used to detachably attach a sunshade clip to the spectacles in accordance with a first embodiment of the present invention. FIG. 3 is a partially broken away perspective view illustrating an alternative embodiment of the attachment unit shown in FIG. 2, and FIG. 4 is a side sectional view illustrating a coupled state of the attachment unit.

As stated above, the attachment unit 40 comprises the clip attachable means provided at the spectacles 30 for the attachment of the sunshade clip 35, namely, a clip attachable member 41, and the spectacles attachable means provided at the sunshade clip 35 for the attachment of the spectacles 30, namely, a spectacles attachable member 42.

The clip attachable member 41 includes a fixing protrusion 46 which protrudes outward from an outer end of either lens frame 32 for retaining the lens 31, and a holding piece 47 fastened to the fixing protrusion 46 by means of a bolt 45 in close contact with a lower surface of the fixing protrusion 46.

The clip attachable member 41 further includes a clip attachable body 48 extended upward from a rear end of the holding piece 47 in contact with and at approximately the same level as the fixing protrusion 46, and a receiving space 49 centrally recessed in an upper surface of the clip attachable body 48, in which the sintered metal fibers 36 and 37 are received.

On the other hand, the spectacles attachable member 42 includes a fixing protrusion 50 provided at an outer end of either lens frame 32′ of the sunshade clip 35, and a holding piece 52 fastened to the fixing protrusion 50 by means of a bolt 51 in contact with an upper surface of the fixing protrusion 50. The holding piece 52 has a sufficient length to be adjoined to the fixing protrusion 46 provided at the spectacles 30.

The spectacles attachable member 42 further includes a spectacles attachable body 53 formed at a rear end of the holding piece 52, and a receiving space 54 perforated in the spectacles attachable body 53, in which the magnet 43, capable of magnetically attracting the metal fibers 36 and 37, is received.

In an alternative embodiment, the holding pieces 47 and 52 of the clip attachable member 41 and the spectacles attachable member 42 may be welded to the fixing protrusions 46 and 50, respectively, instead of being fastened thereto using the bolts 45 and 51. Further, in another alternative embodiment as shown in FIG. 3, the clip attachable body 48 of the clip attachable member 41 may be integrally fixed relative to an inner side of either temple arm 34, rather than to the fixing protrusion 46.

In the latter case, the clip attachable body 48 of the clip attachable member 41 is preferably affixed between hinges formed at both the fixing protrusion 46 and the temple arm 34.

In this way, according to the present embodiment, the spectacles attachable member 42 is vertically attachable to the clip attachable member 41 from an upper side of the member 41.

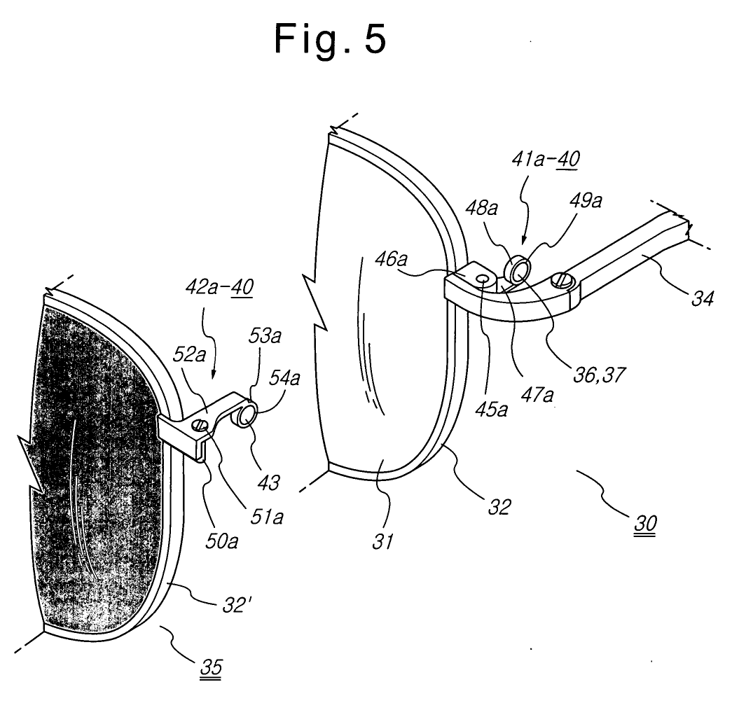

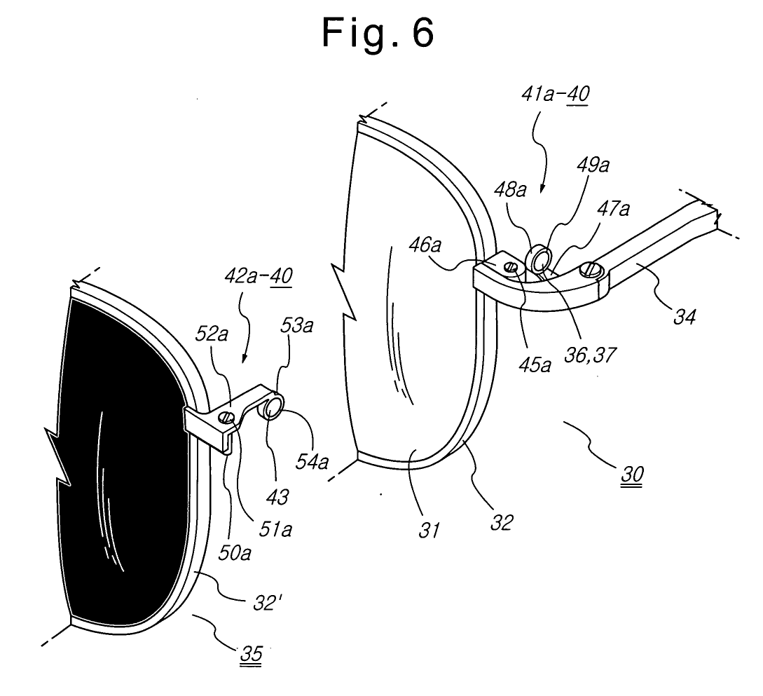

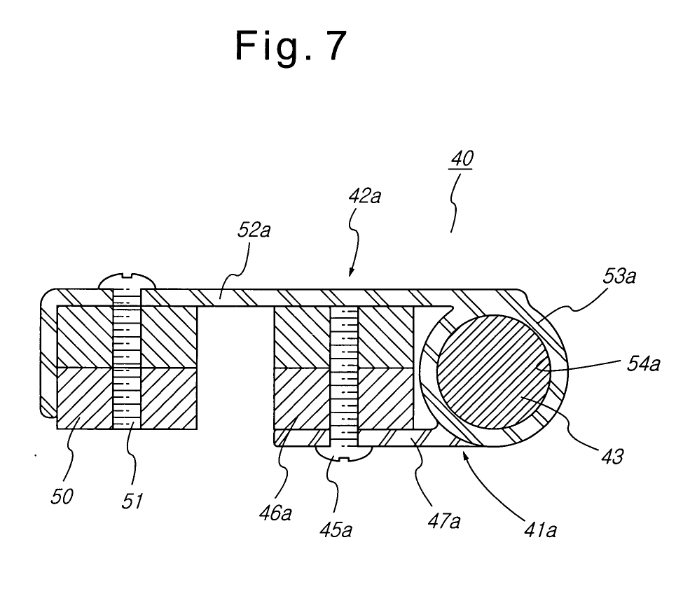

Reference is now made to FIG. 5 to 7. FIG. 5 is a partially broken away perspective view illustrating an attachment unit in accordance with a second embodiment of the present invention. FIG. 6 is a partially broken away perspective view illustrating an alternative embodiment of the attachment unit shown in FIG. 5, and FIG. 7 is a side sectional view illustrating a coupled state of the attachment unit.

In the present embodiment, a clip attachable member 41a includes a fixing protrusion 46a attached to an outer end of either lens frame 32 of the spectacles 30, a holding piece 47a fastened to a lower surface of the fixing protrusion 46a by means of a bolt 45a so that it extends rearward from the fixing protrusion 46a, a clip attachable body 48a extended upward from a rear end of the holding piece 47a at a distance from the fixing protrusion 46a, a receiving space 49a perforated laterally through the clip attachable body 48a for receiving the sintered metal fibers 36 and 37 therein.

A spectacles attachable member 42a of the present embodiment includes a fixing protrusion 50a provided at an outer end of either lens frame 32′ of the sunshade clip 35, and a holding piece 52a fastened to the fixing protrusion 50a by means of a bolt 51a in contact with an upper surface of the fixing protrusion 50a, similar to the previous embodiment. The holding piece 52a has a sufficient length to be adjoined to the fixing protrusion 46a provided at the spectacles 30.

The spectacles attachable member 42a further includes a spectacles attachable body 53a extended downward from a rear end of the holding piece 52a, and a receiving space 54a defined in an outer lateral surface of the spectacles attachable body 53a, in which the magnet 43, capable of magnetically attracting the sintered metal fibers 36 and 37, is received.

In this way, according to the present embodiment, the spectacles attachable member 42a is laterally attachable to the clip attachable member 41a from an inner side of the member 41a.

In an alternative embodiment, the holding pieces 47a and 52a of the clip attachable member 41a and the spectacles attachable member 42a may be welded to the fixing protrusions 46a and 50a, respectively, instead of being fastened thereto using the bolts 45a and 51a.

In another alternative embodiment as shown in FIG. 6, the holding piece 47a of the clip attachable member 41a is integrally extended from an inner side of either temple arm 34, so that the clip attachable body 48a of the clip attachable member 41a may be integrally fixed relative to the temple arm 34, rather than to the fixing protrusion 46a.

In this case, preferably, the clip attachable body 48a of the clip attachable member 41 may be affixed between hinges formed at both the fixing protrusion 46a and the temple arm 34.

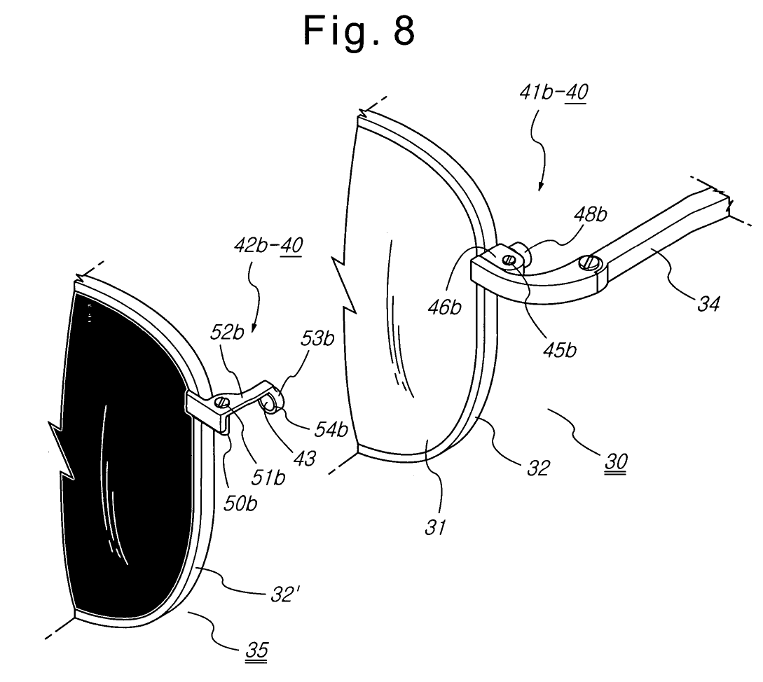

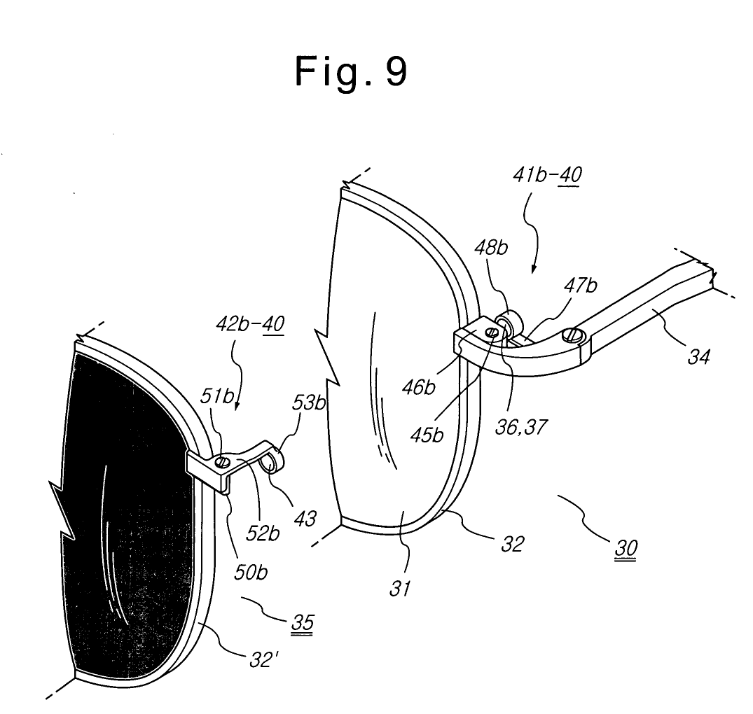

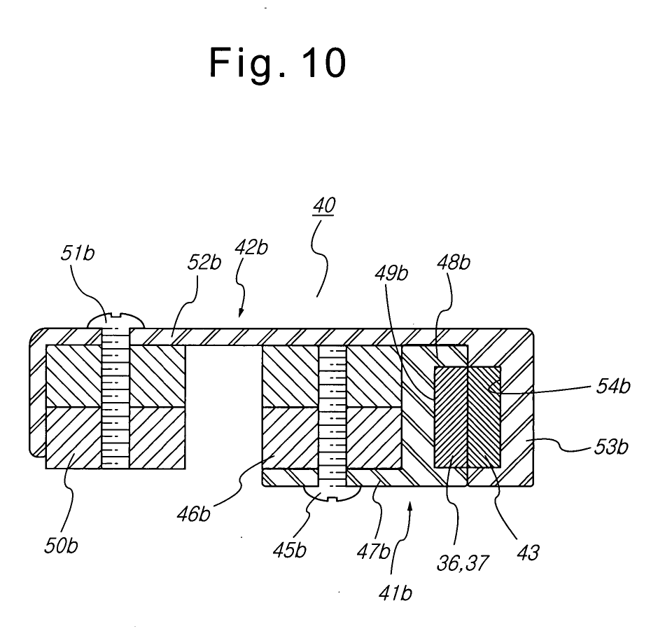

Reference is now made to FIGS. 8 to 10. FIG. 8 is a partially broken away perspective view illustrating an attachment unit in accordance with a third embodiment of the present invention. FIG. 9 is a partially broken away perspective view illustrating an alternative embodiment of the attachment unit shown in FIG. 8, and FIG. 10 is a side sectional view illustrating a coupled state of the attachment unit.

In the present embodiment, a clip attachable member 41b includes a fixing protrusion 46b attached to an outer end of either lens frame 32 of the spectacles 30, a holding piece 47b fastened to a lower surface of the fixing protrusion 46b by means of a bolt 45b, a clip attachable body 48b formed by bending a rear end portion of the holding piece 47b so that it extends upward in perpendicular thereto, and a receiving space 49b recessed in a rear surface of the clip attachable body 48b, in which the sintered metal fibers 36 and 37 are received.

A spectacles attachable member 42b of the present embodiment includes a fixing protrusion 50b provided at an outer end of either lens frame 32′ of the sunshade clip 35, and a holding piece 52b fastened to the fixing protrusion 50b by means of a bolt 51b in contact with an upper surface of the fixing protrusion 50b. The holding piece 52b has a sufficient length to be adjoined to the fixing protrusion 46b provided at the spectacles 30.

The spectacles attachable member 42b further includes a spectacles attachable body 53 formed by bending a rear end portion of the holding piece 52b so that it extends downward in perpendicular thereto, and a receiving space 54b defined in a front surface of the spectacles attachable body 53b, in which the magnet 43, capable of magnetically attracting the sintered metal fibers 36 and 37, is received.

In this way, according to the present invention, the spectacles attachable member 42b is attachable to the clip attachable member 41b in front and rear.

In an alternative embodiment, the holding pieces 47b and 52b of the clip attachable member 41b and the spectacles attachable member 42b may be welded to the fixing protrusions 46b and 50b, respectively, instead of being fastened thereto using the bolts 45b and 51b.

In another alternative embodiment as shown in FIG. 9, the holding piece 47b of the clip attachable member 41b may be extended inward from an inner side of either temple arm 34, so that the clip attachable body 48b is integrally fixed relative to the temple arm 34, rather than to the fixing protrusion 46b.

In this case, preferably, the clip attachable body 48b of the clip attachable member 41b is affixed between hinges formed at both the fixing protrusion 46b and the temple arm 34.

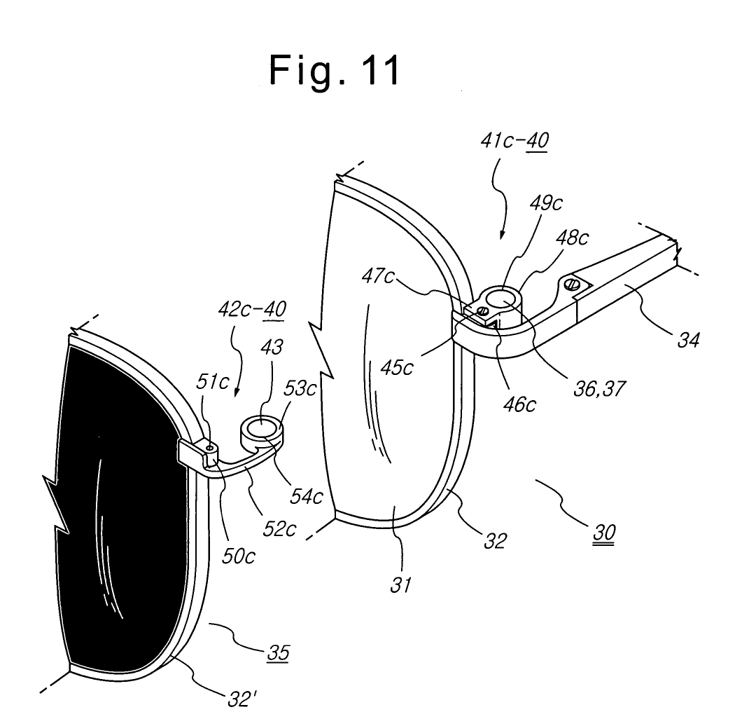

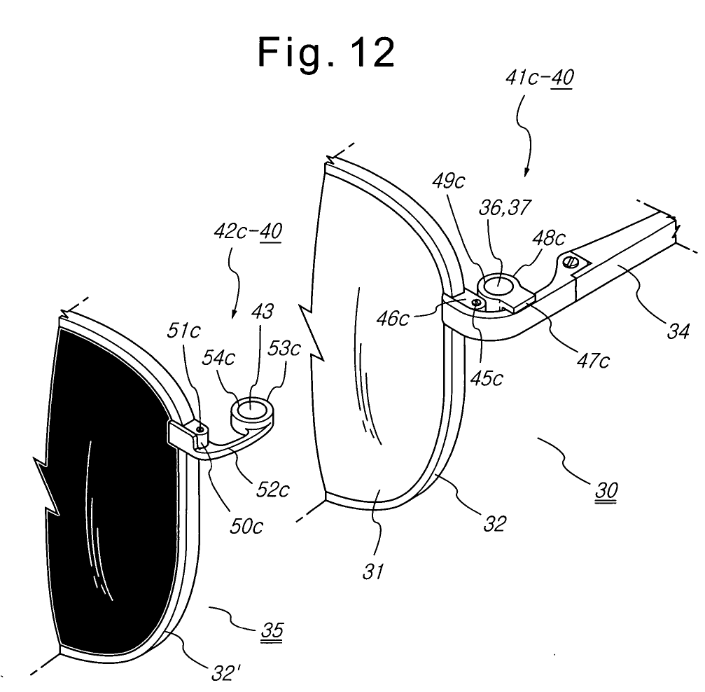

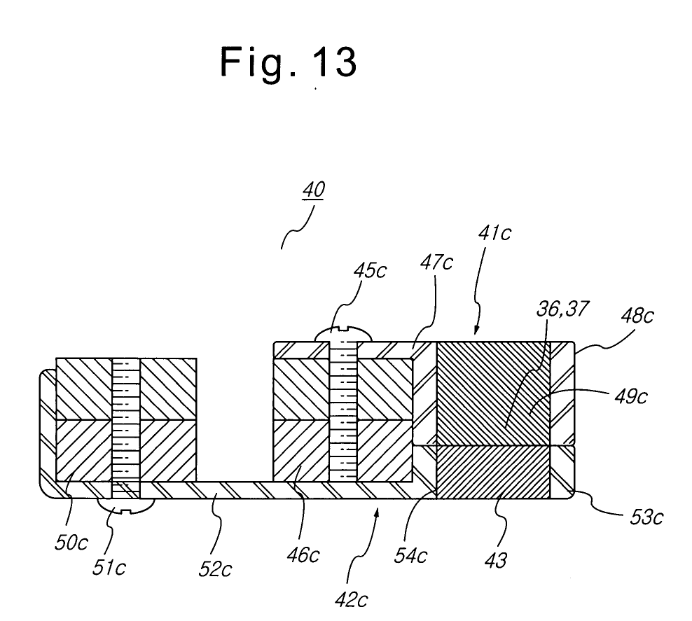

Reference is now made to FIGS. 11 to 13. FIG. 11 is a partially broken away perspective view illustrating an attachment unit in accordance with a fourth embodiment of the present invention. FIG. 12 is a partially broken away perspective view illustrating an alternative embodiment of the attachment unit shown in FIG. 11, and FIG. 13 is a side sectional view illustrating a coupled state of the attachment unit.

In the present embodiment, a clip attachable member 41c includes a fixing protrusion 46c attached to an outer end of either lens frame 32 of the spectacles 30, a holding piece 47c fastened to an upper surface of the fixing protrusion 46c by means of a bolt 45c, a clip attachable body 48c extended downward from a rear end of the holding piece 47c, and a receiving space 49c centrally recessed in a lower surface of the clip attachable body 48, in which the sintered metal fibers 36 and 37 are received.

A spectacles attachable member 42c of the present embodiment includes a fixing protrusion 50c provided at an outer end of either lens frame 32′ of the sunshade clip 35, and a holding piece 52c fastened to the fixing protrusion 50c by means of a bolt 51c in contact with a lower surface of the fixing protrusion 50c. The holding piece 52c has a sufficient length to be adjoined to the fixing protrusion 46c provided at the spectacles 30.

The spectacles attachable member 42c further includes a spectacles attachable body 53c formed at a rear end of the holding piece 52c, and a receiving space 54c perforated in the spectacles attachable body 53c, in which the magnet 43, capable of magnetically attracting the sintered metal fibers 36 and 37, is received.

In this way, according to the present invention, the spectacles attachable member 42c is vertically attachable to the clip attachable member 41c from a lower side of the member 41c.

In an alternative embodiment, the holding pieces 47c and 52c of the clip attachable member 41c and the spectacles attachable member 42c may be welded to the fixing protrusions 46c and 50c, respectively, instead of being fastened thereto using the bolts 45c and 51c.

In another alternative embodiment, the holding piece 47c of the clip attachable member 41c may be fixed to either temple arm 34, so that the clip attachable body 48c is integrally fixed relative to the temple arm 34, rather than to the fixing protrusion 46b.

In this case, preferably, the clip attachable body 48c of the clip attachable member 41c may be affixed between hinges formed at both the fixing protrusion 46c and the temple arm 34.

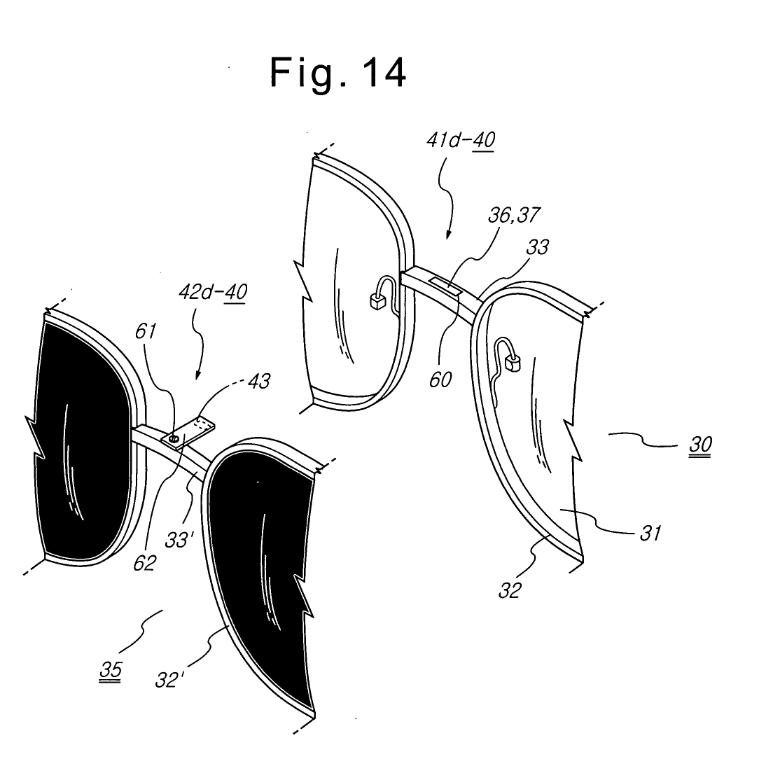

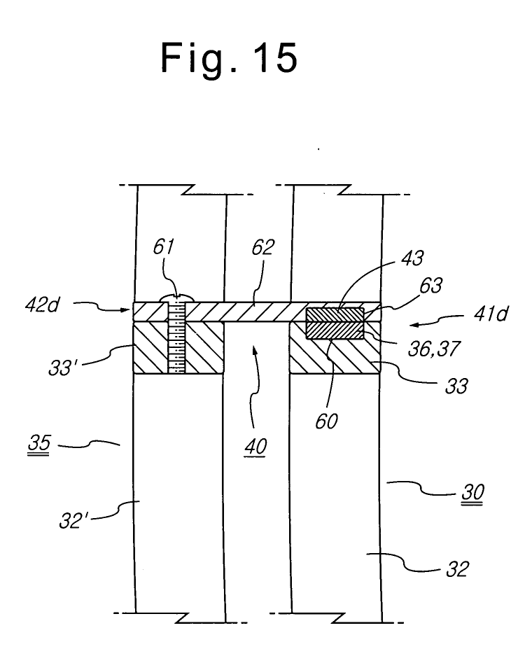

Reference is now made to FIGS. 14 and 15. FIG. 14 is a partially broken away perspective view illustrating an attachment unit in accordance with a fifth embodiment of the present invention. FIG. 15 is a side sectional view illustrating a coupled state of the attachment unit.

In the present embodiment, a clip attachable member 41d includes a receiving space 60 defined in an upper surface of the nose frame 33, which connects the adjacent inner ends of both the lens frames 32 of the spectacles 30. Inside the receiving space 60 are received the sintered metal fibers 36 and 37.

A spectacles attachable member 42 of the present invention has an attachable piece 62, which is fastened to an upper surface of the nose frame 33′ of the sunshade clip 35 by means of a bolt 61. The attachable piece 62 has a sufficient length to be adjoined to the nose frame 33 of the spectacles 30.

The attachable piece 62 is defined in one end of its lower surface with a receiving space 63, in which the magnet 43, capable of magnetically attracting the metal fibers 36 and 37, is received.

In this way, according to the present embodiment, the spectacles attachable member 42d is vertically attachable to the clip attachable member 41d from an upper side of the member 41.

Of course, the spectacles attachable member 42d may be welded to the nose frame 33′ of the sunshade clip 35, instead of being fastened using the bolt 61.

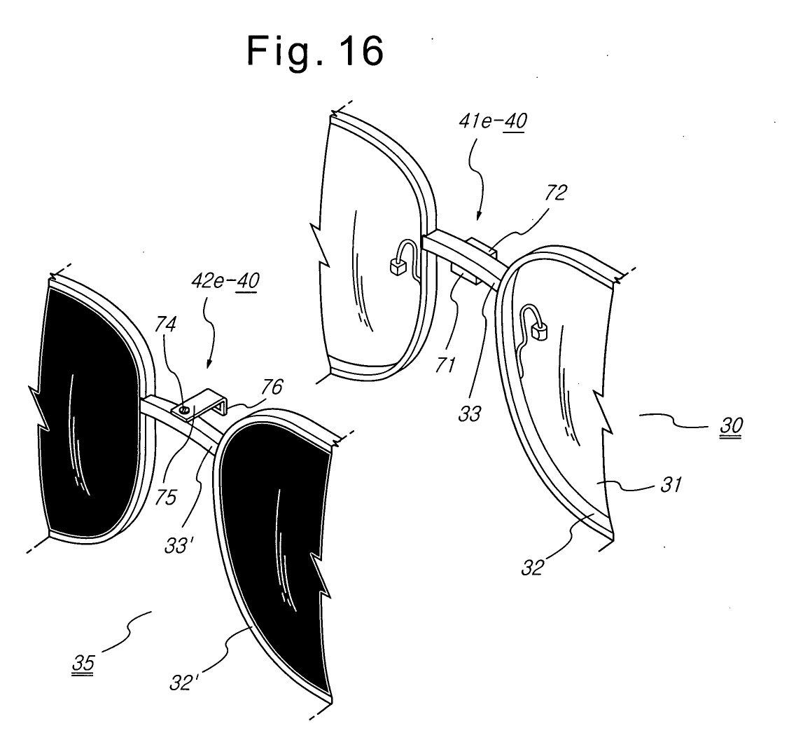

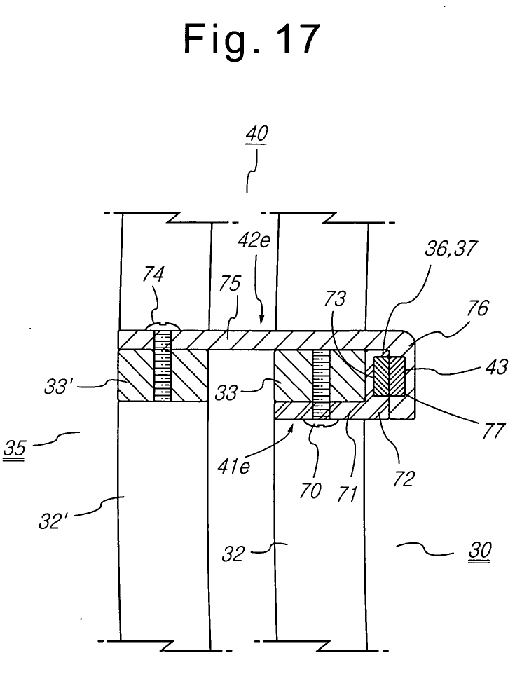

Reference is now made to FIGS. 16 and 17. FIG. 16 is a partially broken away perspective view illustrating an attachment unit in accordance with a sixth embodiment of the present invention. FIG. 17 is a side sectional view illustrating a coupled state of the attachment unit.

In the present embodiment, a clip attachable member 41e includes a holding piece 71 fastened to a lower surface of the nose frame 33 of the spectacles 30 by means of a bolt 70, and a clip attachable body 72 formed by upwardly bending a rear end portion of the holding piece 71 so that it extends upward in perpendicular thereto.

The clip attachable body 72 is defined in a rear surface thereof with a receiving space 73, in which the sintered metal fibers 36 and 37 are received.

A spectacles attachable member 42e of the present embodiment includes a holding piece 75, which is fastened to an upper surface of the nose frame 33′ of the sunshade clip 35 by means of a bolt 74. The holding piece 75 has a sufficient length to be adjoined to the nose frame 33 of the spectacles 30.

The spectacles attachable member 42e further includes a spectacles attachable body 76 formed by bending a rear end portion of the holding piece 75 so that it extends downward in perpendicular thereto. The spectacles attachable body 76 is defined in a front surface thereof with a receiving space 77, in which the magnet 43, capable of magnetically attracting the sintered metal fibers 36 and 37, is received.

In this way, according to the present embodiment, the spectacles attachable member 42e is horizontally attachable to the clip attachable member 41e in front and rear.

Of course, the spectacles attachable member 42e may be welded to the nose frame 33 of the spectacles 30, instead of being fastened using the bolt 74.

Considering now the operation and effects of the present invention, by forming part of the spectacles 30 and the sunshade clip 35, or the attachment unit 40 by making use of the sintered metal fibers 36 and 37 wherein a desired perfume selected by the wearer is injected into extremely fine voids (S) inherent therein, the present invention enables a fragrance to be continuously emitted for a certain long period.

For example, when the spectacles 30 are used alone without the sunshade clip 35, the lens frames 32, nose frame 33 and temple arms 34 of the spectacles 30 are formed by making use of the sintered metal fibers 36 and 37, thereby allowing a perfume to be injected into the fine voids (S) inherent between the sintered metal fibers 36 and 37, resulting in improvement of wearability.

When the sunshade clip 35 is attached to the spectacles 30 by means of the attachment unit 40 so as to be used as a substitute for sunglasses, in the clip attachable member of the attachment unit 40 provided at the spectacles 30 are received the sintered metal fibers 36 and 37, whereas in the spectacles attachable member provided at the sunshade clip 35 is received the magnet 43, thereby allowing the spectacles 30 and the sunshade clip 35 to be detachably attached to each other.

In this state, as a perfume is injected between the metal fibers 36 and 37 received in the receiving space of the clip attachable member provided at the spectacles 30, it can emit a fragrance in a worn state of the spectacles 30 as well as in a worn state of the sunshade clip 35, resulting in improvement of wearability.

When it is desired to change fragrances, the sintered metal fibers 36 and 37 are dried by means of appropriate heating means, for example, a hair drier, until the perfume inside the fine voids (S) between the metal fibers 36 and 37 is completely dried and removed.

In this way, the wearer can freely change a perfume according to his/her taste or required atmosphere conditions. This has an effect of improving wearbility of the spectacles as well as providing pleasantness to other people near the wearer.

In the present invention, preferably, the metal fibers 36 and 37 are constructed to contain more Fe within an acceptable range in order to increase magnetic attraction between the sintered metal fibers 36 and 37 and the magnet 43. Thereby, the sunshade clip 35 is easily attachable to the spectacles 30.

Further, regardless of kinds and manners of the spectacles and clip attachable members provided at the sunshade clip 35 and the spectacles 30, the sintered metal fibers 36 and 37 can be contained in the clip attachable member in correspondence to the magnet, or alternatively, in the spectacles attachable member, securing free injection of perfume.

Preferably, in consideration of the fact that the spectacles 30 are constantly worn by the wearer, the metal fibers 36 and 37 are contained in the clip attachable member 41 of the spectacles 30.

More preferably, when the attachment unit 40, used to detachably attach the sunshade clip 35 to the spectacles 30, is provided with the sintered metal fibers 36 and 37 so that a fragrance is emitted from a perfume injected in the fine voids (S) of the sintered metal fibers 36 and 37, the fragrance can be delivered even to other people near the wearer, giving rise to a pleasant atmosphere.

As apparent from the above description, the present invention provides a sunshade clip attachable to spectacles, which can allow a fragrance to be continuously emitted from a perfume injected in the spectacles and the sunshade clip for a certain long time, thereby creating a pleasant atmosphere around a wearer of the spectacles, and contributing improvement in the quality of the spectacles as well as the sunshade clip.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sunshade clip attachable to spectacles, the spectacles comprising: a pair of lens frames for retaining prescription lenses, respectively; a nose frame connecting adjacent inner ends of both the lens frames; and temple arms extended rearward from opposite outer ends of both the lens frames for allowing the spectacles to be worn on the wearer's ears, the sunshade clip comprising: a pair of lens frames for retaining colored lenses, respectively; and a nose frame connecting adjacent inner ends of both the lens frames, wherein
at least one attachment unit is provided for detachably attaching the sunshade clip to the spectacles, the attachment unit comprising:
a clip attachable member provided at the spectacles for enabling the spectacles to be attached to the sunshade clip, the clip attachable member being fixable to either frame or temple arm, or the nose frame of the spectacles; and
a spectacles attachable member provided at the sunshade clip for enabling the sunshade clip to be attached to the spectacles.

2. The sunshade clip as set forth in claim 1, wherein the clip attachable member comprises:
a fixing protrusion which protrudes outward from an outer end of either lens frame for retaining an associated one the lenses;
a holding piece fastened to the fixing protrusion by means of a bolt in close contact with a lower surface of the fixing protrusion;
a clip attachable body extended upward from a rear end of the holding piece in contact with and at approximately the same level as the fixing protrusion; and
a receiving space centrally recessed in an upper surface of the clip attachable body, in which sintered metal fibers are received; and
wherein the spectacles attachable member comprises:
a fixing protrusion provided at an outer end of either lens frame of the sunshade clip;
a holding piece fastened to the fixing protrusion by means of a bolt in contact with an upper surface of the fixing protrusion;
a spectacles attachable body formed at a rear end of the holding piece; and
a receiving space perforated in the spectacles attachable body, in which a magnet, capable of magnetically attracting the sintered metal fibers, is received,
whereby: the spectacles attachable member is vertically attachable to the clip attachable member from an upper side of the member; and
into the sintered metal fibers is injected a perfume so as to diffuse a fragrance for a long time, thereby improving wearability of the spectacles and the sunshade clip as well as creating a pleasant atmosphere.

3. The sunshade clip as set forth in claim 2, wherein the sintered metal fibers are obtained by sintering metal fibers, each having a length of 50 μm to 500 μm and a thickness of 10 μm to 100 μm obtained through grinding of raw metal, to have a porosity of 30% to 90% and a density of 0.7 g/cc to 6.0 g/cc, the sintered metal fibers having defining fine voids defined therebetween.

4. The sunshade clip as set forth in claim 2, wherein the metal fibers take the form of an adhesive pad, which is attachable to an appropriately selected position of respective components of the spectacles.

5. The sunshade clip as set forth in claim 2, wherein the sintered metal fibers are contained in the clip attachable member provided at the spectacles for allowing the wearer to constantly feel pleasantness.

6. The sunshade clip as set forth in claim 2, wherein the sintered metal fibers consist of 0.021% by weight of carbon (C), 0.89% by weight of silicone (Si), 0.24% by weight of manganese (Mn), 0.02% by weight of phosphorous (P), 0.007% by weight of sulfur (S), 0.16% by weight of nickel (Ni), 16.33% by weight of chrome (Cr), 0.01% by weight of molybdenum (Mo), 0.01% by weight of copper (Cu), and 82.312% by weight of iron (Fe).

7. The sunshade clip as set forth in claim 2, wherein the holding pieces of the clip attachable member and the spectacles attachable member are welded to fixing protrusions, respectively.

8. The sunshade clip as set forth in claim 1, wherein the clip attachable member provided at the spectacles is fixed to an inner side of either temple arm.

9. The sunshade clip as set forth in claim 1, wherein the clip attachable member comprises:
a fixing protrusion attached to an outer end of either lens frame of the spectacles;
a holding piece fastened to a lower surface of the fixing protrusion so that it extends rearward from the fixing protrusion;
a clip attachable body extended upward from a rear end of the holding piece at a distance from the fixing protrusion; and
a receiving space perforated laterally through the clip attachable body, in which sintered metal fibers are received; and
wherein the spectacles attachable member comprises:
a fixing protrusion provided at an outer end of either lens frame of the sunshade clip;
a holding piece fastened to the fixing protrusion in contact with an upper surface of the fixing protrusion;
a spectacles attachable body extended downward from a rear end of the holding piece; and
a receiving space defined in an outer lateral surface of the spectacles attachable body, in which a magnet, capable of magnetically attracting the metal fibers, is received,
whereby the spectacles attachable member is laterally attachable to the clip attachable member from an inner side of the clip attachable member.

10. The sunshade clip as set forth in claim 1, wherein the clip attachable member comprises:
a fixing protrusion attached to an outer end of either lens frame of the spectacles;
a holding piece fastened to a lower surface of the fixing protrusion;
a clip attachable body formed by bending a rear end portion of the holding piece so that it extends upward in perpendicular thereto; and
a receiving space recessed in a rear surface of the clip attachable body, in which sintered metal fibers are received; and
wherein the spectacles attachable member comprises:
a fixing protrusion provided at an outer end of either lens frame of the sunshade clip;
a holding piece fastened to the fixing protrusion in contact with an upper surface of the fixing protrusion;
a spectacles attachable body formed by bending a rear end portion of the holding piece so that it extends downward in perpendicular thereto; and
a receiving space defined in a front surface of the spectacles attachable body, in which a magnet, capable of magnetically attracting the metal fibers, is received,
whereby the spectacles attachable member is attachable to the clip attachable member 41b in front and rear.

11. The sunshade clip as set forth in claim 1, wherein the clip attachable member comprises:
a fixing protrusion attached to an outer end of either lens frame of the spectacles;
a holding piece fastened to an upper surface of the fixing protrusion;
a clip attachable body extended downward from a rear end of the holding piece; and
a receiving space centrally recessed in a lower surface of the clip attachable body, in which sintered metal fibers are received; and
wherein the spectacles attachable member comprises:
a fixing protrusion provided at an outer end of either lens frame of the sunshade clip;
a holding piece fastened to the fixing protrusion in contact with a lower surface of the fixing protrusion;
a spectacles attachable body formed at a rear end of the holding piece; and
a receiving space perforated in the spectacles attachable body, in which a magnet, capable of magnetically attracting the metal fibers, is received,
whereby the spectacles attachable member is vertically attachable to the clip attachable member from a lower side of the clip attachable member.

12. The sunshade clip as set forth in claim 1, wherein the clip attachable member comprises:
a receiving space defined in an upper surface of the nose frame, which connects the adjacent inner ends of both the lens frames of the spectacles, in the receiving space being received sintered metal fibers; and
wherein the spectacles attachable member comprises:
an attachable piece, which is fastened to an upper surface of the nose frame of the sunshade clip,
a receiving space defined in one end of a lower surface of the attachable piece, in which a magnet, capable of magnetically attracting the sintered metal fibers, is received,
whereby the spectacles attachable member is vertically attachable to the clip attachable member from an upper side of the clip attachable member.

13. The sunshade clip as set forth in claim 1, wherein the clip attachable member comprises:
a holding piece fastened to a lower surface of the nose frame;
a clip attachable body formed by upwardly bending a rear end portion of the holding piece so that it extends upward in perpendicular thereto; and.
a receiving space defined in a rear surface thereof, in which sintered metal fibers are received; and
wherein the spectacles attachable member comprises:
a holding piece, which is fastened to an upper surface of the nose frame of the sunshade clip;
a spectacles attachable body formed by bending a rear end portion of the holding piece so that it extends downward in perpendicular thereto; and
a receiving space defined in a front surface thereof, in which a magnet, capable of magnetically attracting the sintered metal fibers, is received,
whereby the spectacles attachable member is horizontally attachable to the clip attachable member in front and rear.
